(19) United States
(12) Patent Application Publication
(10) Pub. No.: US 2007/0154871 A1
(43) Pub. Date: Jul. 5, 2007

(54) Time/life theory

(76) Inventor: Marc Daniel Kramis, Boise, ID (US)

Correspondence Address: Marc Kramis, P.O. Box 7661, Boise, ID, 83707, US

(21) Appl. No.: 11/323,897

(22) Filed: Dec. 30, 2005

(51) Int. Cl. G09B 19/00; G06F 19/00

(52) U.S. Cl. 434/245; 702/1

(57) ABSTRACT

Physicists, astronomers and cosmologists agree the universe is composed of an infinitesimal amount of matter and an overwhelming volume of space and time. While science labors to define reality in terms of mass and matter, and generally accepts the relationship between space and time, it has yet to define the nature of time itself. That definition is important because time is the medium in which all else exists. Time/life theory posits time is three distinct dimensions that coexist in a dynamic balance. It theorizes time is the foundation of physical existence, and life is its experience.

### BACKGROUND OF THE INVENTION

The central function of science is observation and interpretation of physical phenomena. It does this to enhance Man's understanding of the reality, thus improving our enjoyment of life.

When inexplicable phenomena are encountered, man develops theories to explain them. This reaction spawned the development of religion and science. Theories are never complete, however, because new observations are subsequently made that old theories do not address.

As the practice of composing theories on incomplete data sets cannot be avoided, it is periodically necessary to formulate new theories. To be viable, theories must be supported by the facts and demonstrate their validity by demystifying otherwise unexplained phenomena through new and useful perspectives on reality.

In the past 100 years several significant discoveries have been made that science labors to explain. In the early 20th century Edwin Hubble made an observation that shook the world. He discovered nebulae in the night skies were actually other galaxies outside the Milky Way galaxy and the farther away they are, the faster they are receding.

Both science and religion were perplexed by this discovery and at a loss to explain it. A Belgian priest and physicist, Georges LeMaitre, formulated the theory most accepted today. He called it the Cosmic Egg. For years his theory was rejected, though, because of its religious origins. One sarcastic journalist even called it “The Big Bang.”

In 1915 Karl Schwarzschild predicted the existence of black holes and in the 1980's Stephen Hawking theorized matter falling into black holes would leave an x-ray signature as it crossed the hole's event horizon. Astronomical observations appear to confirm their theories and black holes have since been found in abundance by seeking that x-ray signature.

In the 1990's most cosmologists assumed the expansion of the universe from the Big Bang was slowing down. Saul Perlmutter proposed to ascertain the rate of its deceleration.

In 1998 Perlmutter's Supernova Cosmology Project published the results of their observations. To nearly everyone's surprise, it indicated the expansion was accelerating rather than decelerating. The observations indicated an acceleration rate that would attain the speed of light in less than 14 billion years from any given starting point.

On Jun. 30, 2001 NASA launched the Wilkinson Microwave Anisotropy Probe (WMAP) to examine the Comic Microwave Background (CMB), a ubiquitous radiation thought to be left over from the Big Bang. When the results came in Robert Nemiroff of Michigan Tech University and Jerry Bonnell of the Universities Space Research Association announced ”. . . present analyses of the WMAP all-sky image indicate that the universe is 13.7 billion years old . . . ”

Assuming the accuracy of these conclusions, it establishes the observational horizon of the past at 13.7 billion years (in any given direction from Earth). In other words, Earth is suspended at the exact center of an observational sphere 27.4 billion light years in diameter.

The math of these crucial observations in combination with the partially confirmed large scale homogeneity of the universe paint a simple picture that defies orthodox explanation. Not only is earth suspended at the center of the universe, the matter in that universe is somehow being replaced at a rate more or less equal to its attrition over the observational horizon of the past (marked by microwaves) and the event horizon of every black hole (marked by x-rays). As microwaves and x-ray lie at opposite ends of the electromagnetic (EM) spectrum, it is reasonable to hypothesize black holes lie at the opposite end of the time spectrum from the CMB.

Today's theories do not adequately address this concept, however, because (like all other theories) they were based on incomplete data sets that made assumptions to fill the holes where there was no data.

Two of their key assumption are, “Life is a rarity in the universe” and “The universe began with the Big Bang.” These assumptions are unspoken, yet generally assumed valid in relativity and string theories of the universe based on 4-11 dimensions.

An important condition of the first assumption is the definition of life. For the purpose of time/life theory that definition simply reads “the experience of time.”

The second assumption was made because very little was known about the nature of universe in the early 20th century. Nevertheless, the universe may be older than we can imagine if it is a self regenerative medium in which every point lies at its center and the CMB merely marks its observational limits from that point.

### DETAILED DESCRIPTION OF THE INVENTION

The invention is a formula that defines physical existence as a function of time and life. In conjunction with other evidence, it also predicts a probability of reincarnation.

The formula (FIG. 1) describes life as the total of all energy received and transmitted by any physical entity from the beginning of its existence to its end. This definition applies to any set of physical objects from single subatomic particle to multiple universes.

As this applies to a human being, it means if a man dies at the age of 40, his total experience of time can include only those things contained within (and light from more distant objects that has already entered) a sphere 40 light years in radius from the time and place of his birth. It also means that at the time of his death, his entire life might be observed by a spectator located 40 light years away over the following 40 years (assuming the technology existed to permit it).

Physical objects receive and reflect energy for the duration of their existence. The pattern of that received and reflected energy is spherically concentric and parsed in the second part of the equation in FIG. 1. Alpha/omega (αω) represents the duration of that transmission from beginning to end.

Any single αω unit of time may be subdivided into smaller αω units such as cycles, rotations or oscillations. αω units may thus be grouped into sets, divided into subsets or added to other objects to form supersets.

Human beings commonly use subsets (of the larger αω birth to death unit) to divide their lives into more convenient size pieces (days, months, years, etc.). Not so commonly used by humans is the αω set of successive lives used by individuals like the 14th Dahlia Lama and 17th Gyalwang Karmapa.

Reincarnation as practiced by bodhisattvas like the Dahlia Lama and Gyalwang Karmapa is a variant of the method described herein. In the Buddhist tradition the individual typically departs one corporeal form without a specific next incarnation in mind. This makes the Buddhist practice of reincarnation more art than science. It also makes identification of his/her person in a subsequent life problematic.

The science of Buddhist reincarnation is not recorded, and therefore, does not readily lend itself to instruction. The formula of this invention defines the parameters that make reincarnation possible, thus making it more predictable, communicable and practicable.

The theory of time/life is not difficult to understand and applies to all physical objects in the observable universe. It may be explained conceptually as a mathematical progression beginning with a point traveling through time at the speed of light, c. This motion through time creates a pressure wave in the direction of travel and a vacuum in its wake.

The wave and vacuum causes the point's trajectory to curve and return to its origin along a path that is the circumference of a circle. The ratio of that circle's circumference to its diameter is pi. The radius of that circle is the distance from its center to any point on its circumference.

Where pi times the radius squared represent the area of the circle (a disc), pi times c squared depicts a disc expanding radially at the speed of light in a two dimensional animation, creating a wave and vacuum in two dimensions.

To expand that image from two dimensions to three dimensions, substitute the formula for calculating the surface of a sphere (four times pi times the radius squared) and insert c for the radius value. This describes a sphere whose surface is expanding at the speed of light.

This calculation, however, only takes us part way to the description of physicality because the origin point of the expansion with that formula is located on the surface of the sphere, and the origin point of radiant energy in this universe lies at the center of the sphere. To relocate the origin point to the center of the sphere (FIG. 2) the calculation reads four times pi times c cubed. We now have a mathematical model for a spherical surface radiating from a central point at the speed of light.

The reciprocal value of this animation is found by dividing that value (four times pi times c cubed) by the imaginary unit, whose value is minus one. This creates an animation of a spherical surface collapsing toward a central point at the speed of light. Light and gravity are the forces created by the light speed expansions and collapses (respectively) of objects created in this image.

The key component in this equation is the dimension of time. Expansion and collapse in the dimension of time is the foundation of physical existence responsible for light, gravity and matter.

Light speed is a value rooted in time.

Time is composed of three dimension: past, present and future.

The past is an ever expanding infinite value.

The future is an ever diminishing infinite value.

The present is the membrane that separates the two.

The ever expanding infinite value of the past surrounds and contains the ever diminishing infinite value of the future.

The membrane between the future and the past is matter, which exists only in the present. Light is the phenomenon created when time flows from the future through the membrane of the present into the past.

Matter encloses all objects and groups of objects (that share a common path to the future) in a common surface.

The mass of an object may be calculated as the set of objects contained by a common surface.

An object may be of any spacial quantum dimension from Planck to universal.

Density is the ratio of any given set of objects to the volume that contains them.

Gender

The two components of the above described animation (expansion and collapse) represent one life cycle. It may also be thought of as either transmission and reception or vice versa. That difference in perception is the basis of gender, a recurring theme in the symphony of life from electrons, protons and neutrons to universe entire.

The formula in FIG. 1 has two possible permutations (FIG. 3) that describe the expansion or collapse phase as a function of the other phase's life (αω). The expansion/collapse animation may thus be viewed preferentially as either expansion then collapse or collapse then expansion.

The expansion first perspective is represented by the male symbol and is manifest at the base level of stable physical existence as a proton.

The collapse first perspective is characterized by the female symbol and manifests at the base level of physical existence as a neutron.

The perception bias gives a slightly greater repulsive (EM) force to the proton and a slightly greater attractive (gravity) force to the neutron.

Electrons represent a potential to become either a proton or neutron resulting in a nearly equal bipolar motivational force.

Matter is defined by the velocity of light. Nothing in the past can exceed the speed of light, nothing in the future can travel at less than the speed of light.

Hyper light velocity is defined as the speed of thought, c+.

c+ is a distance independent velocity that is unfettered by the constraints of matter. Intergalactic distances may be traveled at the same instantaneous rate of speed with which a few inches may be traversed.

Light and gravity (which give mobility to physical objects in the dimension of the past) are also the basis of universal communication. At the sub atomic base level of proton, neutron and electron, the forms illustrated in FIG. 4, 5 & 6 have specific preferences of motion and alignment that allow protons, neutrons and electrons to assume predictable atomic configurations based on environmental conditions that include mass density and temperature.

Atomic configurations, in turn, have preferred motions and alignments that predict probable molecular configurations.

This scaffolding effect of probable configurations based on motions, alignments and environmental conditions at each plateau of physical existence allows the construction of virtually any complex physical form including planets, bacteria, galaxies, stars and human beings.

Reproduction of an existing form may be accomplished by using similar forms as a template. This is typified in recombinant DNA.

At the heart of every autonomous physical manifestation of matter, however, is a single proton or neutron responsible for initiating the growth of that structure.

The preferred motion and alignment of a single proton or neutron is called its desire. That desire is communicated to other protons, neutrons & electrons through directional, frequency and amplitude variances in their expansion/collapse cycle radiant emissions. Protons, neutrons & electrons receiving those emissions may adapt their own motion and alignment to compliment the received communication, and in turn, radiate a harmonic common desire. This produces a structure whose form may be predicted as a probability in any given environment.

The result of protons, neutrons & electrons forming such a common desire is an atom which forms its own common surface as a set of protons, neutrons & electrons traveling as a unit toward a common future.

The radiant emissions which originated at the initiating proton or neutron, and were then transmitted by other protons, neutrons & electrons as a common desire harmonic, extend the environmental awareness of the initiator and other harmonizers to include all those of common desire. This creates a set of objects with common desire and a common future that encloses and contains them in a common surface.

Probability

The universal constant of time is change. Past, present and future may also be called what was, what is and what will be.

By definition, existence in the future may be (but does not necessarily have to be) different than it was in the past. Probability, however, predicts that the future will eventually be different than the past.

Atoms, molecules and all other stable structures exist as the exception to the law of probable change because of their common desire.

Inanimate objects, plant and animals are three variants of that exception, and are defined by their levels of common desire awareness. Among others, protons and neutrons may experience common desire awareness on an atomic, molecular, organic, cellular or corporate level.

Probable change ultimately wins over the exception, however, because the individual desire of each proton, neutron & electron (which are the foundation of all set and superset structures in the universe) take precedence over any common desire. The law of probability says all things ultimately change.

What this means to human beings is, we get old and die.

Even though we constantly replace those atoms, molecules, etc. (by breathing, eating and drinking) that abandon the common desire (through our breath and urine, or are excised by surgery or other causes) with others who take their place, the desire of the initiating proton or neutron eventually becomes so dim that it too abandons the dream.

When the day comes to abandon the common dream, the initiator experiences a collapse of the harmonic structure of motion and alignment that binds it to the corporate being. It is a conscious decent through the corporate form into the unique future of the proton or neutron initiator where it transverses space at the speed of thought to its next physical form.

What or who will that next physical form be? The purpose of this invention is to provide a method of maximizing the probability of that outcome for any human proton or neutron initiator who desires to experience time in the human form once again.

Reproduction

The preferred motion/alignment of mature protons or neutrons is direct alignment of the male propagation axis with the female collapse axis (FIGS. 4 & 5). This motion/alignment is the strongest force of desire because in this configuration the male and female perspectives achieve maximum common awareness.

When this alignment occurs it places their expansion/collapse origin points in such proximity that it duplicates the equation responsible for their respective existences. This produces a potential to create an electron in the image and likeness of the conjoined proton & neutron.

In a human being, the corporate structure of the human form is an extension of the initiating proton or neutron. When a human dies and descends through its corporate structure into the dimension of that initiator's unique future, it may travel at c+ to a proton/neutron conjunction point where it may reemerge in the physical universe as an electron (FIG. 6).

This allows the conscious awareness of a deceased human to reincarnate first as an electron at the sympathetic proton/neutron junction of the proton initiated (male) human.

When that reincarnated electron matures to either a proton or neutron within the male human host, its desire to create a new human form is communicated to an atomic structure and then a molecular structure and then a DNA structure using the templates within the human male host.

Having only the human male template to work from, however, gives the prospective reincarnate just half of the equation necessary to complete a human structure. The result is a spermatozoon gamete.

To complete the human construct requires a transfer of the gamete to a sympathetic female human host where the spermatozoon fertilizes an ovum gamete construct. The resulting zygote is nurtured within the female human form until the mature fetus reenters the domain of human existence as an infant at the birth event.

Provisos

This formula and method assumes certain conditions necessary for success, and as such, it represents only the possibility of reincarnation. To maximize its probability, the following conditions should also be met.

First, the prospective human reincarnate must actually want to be resurrected as a human being

Second, a sympathetic bond between the deceased and the male host is critical. Without a common desire to travel to a common future, the probability of success is between low and nonexistent

Third, a sympathetic bond between the deceased, the male host and the female host is also critical. Although it is not necessary (theoretically) for the female host to have known the deceased, the probability of a success is diminished by the lack of a sympathetic bond.

The maximum probability of a successful reincarnation involves the enthusiastic participation of the prospective reincarnate as well as the male and female hosts. Any reservations, spoken or concealed will result in a diminution of probable success.

Near physical proximity of the male and female hosts to the prospect at his/her omega point (death), though not critical, will increase the probability of predictable success.

Also noteworthy, human to human reincarnation is not the only possibility. The key to reincarnation is enthusiastic participation. A sympathetic bond between a prospective reincarnate of any species and a same species male/female host pair can result in a successful reincarnation. This means cross species reincarnations are also possible as all life forms use the same proton, neutron and electron building blocks.

Preconceived beliefs and/or conscious awareness of underlying principles are not prerequisite to the final result. Life has existed for longer than any human knows without anyone giving conscious thought to how it works. A sympathetic relationship between the participants is the enabling factor of reincarnation. Intentional application of that formulaic principle increases the probability of a predictable outcome.

METHOD

For the purpose of this formula and method, the terms resurrection and reincarnation are assumed equal and interchangeable.

In as much as the desire of the initiating proton or neutron takes precedence over the common desire of any superset structure to which it may be part, the initiator may choose to abandon the common desire that binds it to its existing corporate form at any point in its existence. This aspect of physical existence allows an improvisation of circumstance to maximize the probability of a desired result.

Constructing a resurrection scenario which will maximize the probability of reincarnating an initiator first involves the preselection of male and female hosts who want to facilitate the resurrection.

The motivation for their participation may be solicited or may be impromptu, as in the case of a male and female that wish to facilitate the resurrection of a dying friend or relative.

The important elements of a predictable reincarnation are the free and willing choice made by the three participants (reincarnate prospect, male host and female host). As free choice is a fluid commodity, timing also plays a hand.

Therefore, maximizing the probability of success involves a timed execution of the key events with the participants in near proximity. The first event is the death (or omega point) of the reincarnate prospect.

Death is an elective event which may be chosen at the discretion of the initiator. In the case of human beings, our society has a long standing taboo against suicide that may stand as a mental barrier to that choice. That issue should be addressed.

The difference between suicide and resurrection is clear and distinct. Suicide is an attempt to escape reality with nothing other than death in mind. It uses physical intervention such as drug overdose or trauma to end life. Resurrection is an embrace of life inspired by the desire to live once more in human form (or eagle, fish, pine tree, whatever). Death is merely an event on the path to that destination.

The conscious choice of the initiator to abandon its current corporate form may be punctuated by an act, such as taking a red pill, to announce the initiator's intent to the rest of the body. This initiates the harmonic collapse of motion and alignment binding the initiator to its corporate form. It normally takes only a few minutes. The first symptom is a noticeable change of perspective which escalates until the initiator passes through the light/matter barrier that separates the past from the future.

When the male host notices a change in the prospect's demeanor, it is appropriate to offer words of comfort like, “As you are about to die now, you will be born again in a world made better by your efforts.”

When it is apparent the initiator has passed from his/her previous incarnation, the male host should say, “You have just died, yet you are born again.” Although the former body of the initiator cannot respond, the initiator is still cognizant and aware of the host's thoughts and words.

Assuming the male host and the reincarnate initiator form a harmonic bond that results in the gamete development phase of the process, the male host may transfer the resulting spermatozoon gamete to the female host during her next ovulation through sexual intercourse.

Rituals and ceremonies may be developed to solemnize various phases of the process. The first phase, for example, may be ritualized by churches, funeral homes, senior citizen centers, retirement homes, hospitals, etc. but it may be conducted anywhere by anyone.

Professions may develop to facilitate the solicitation and training of hosts as well. However, the principles are so simple any healthy male and female of child bearing years may host anyone they choose with nothing more than a rudimentary knowledge of those principles. Maximization of probability is attained through common desire, and minimized by deceit or selfish intent.

While the above described method is designed to maximize predictability, the Buddhist method has also been demonstrated as probable. This means if an individual should die at a location remote from a male host, that initiator can still travel at c+ to any male host who would sponsor his/her resurrection.

The major difference between the Buddhist method and the one described herein is the revelation of the underlying principles that make it possible and the relative ease of identifying the subsequently reincarnated person. These aspects of the invention should make the process attractive and accessible to a global audience.

### BRIEF DESCRIPTION OF THE SEVERAL VIEWS OF THE DRAWING

FIG. 1 is the time/life mathematical formula which reads, “Alpha-Omega equals four times pi times the speed of light cubed, divided by the imaginary unit,” or “Life is radiant reception.”

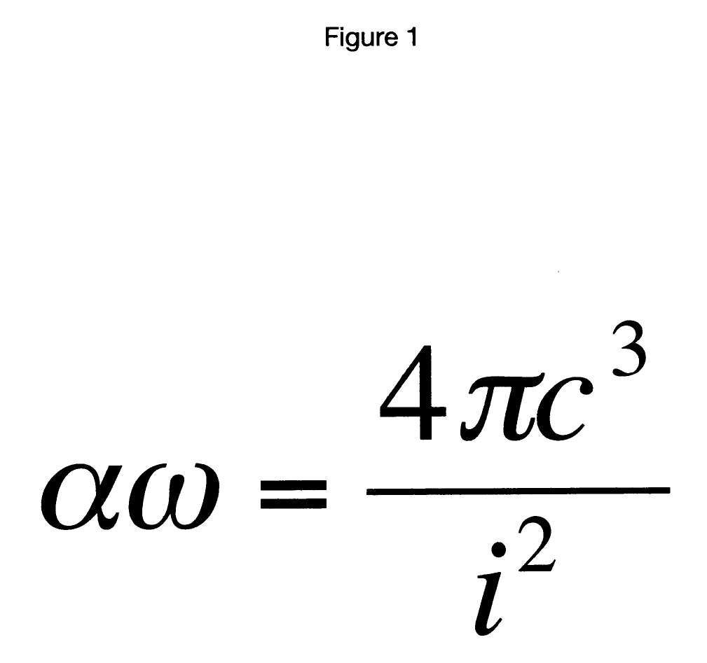

FIG. 2 is a freeze frame depiction of the structure generated by the time/life equation. It depicts the expansion originating at the center point and the collapse phase collapsing toward the center point.

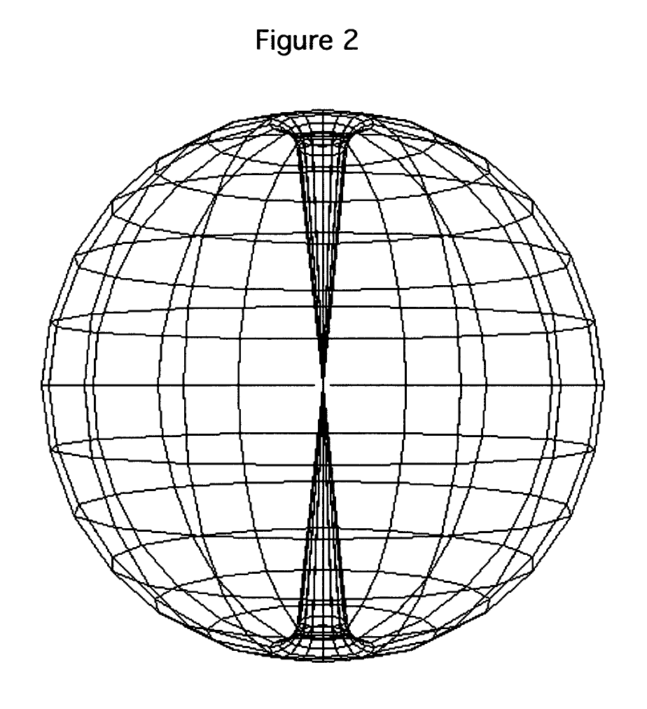

FIG. 3 shows three equations, the time/life equation (at the top) as well as its two primary permutations. The center equation depicts the proton or male perspective of the time/life equation. The bottom equation depicts the neutron or female perspective of the time/life equation.

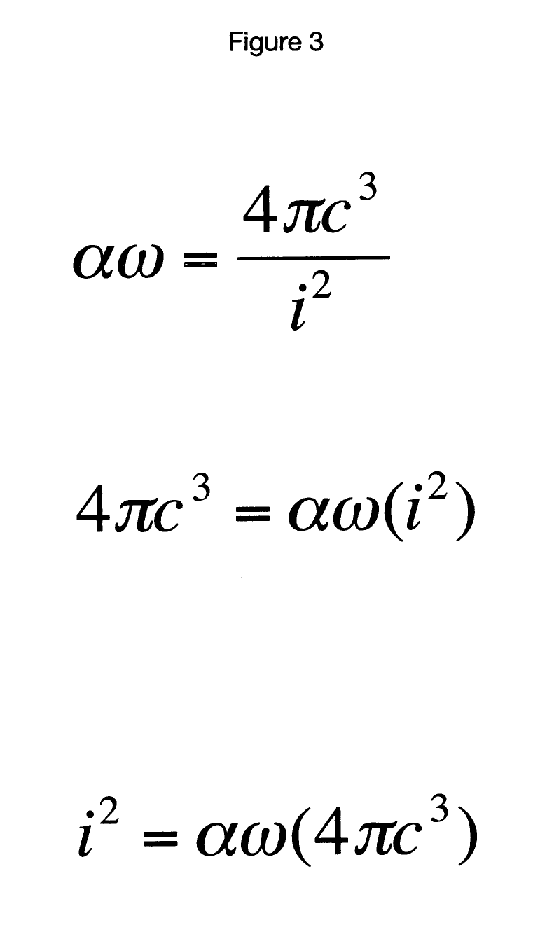

FIG. 4 depicts the form generated by the proton or male perspective of the time/life equation.

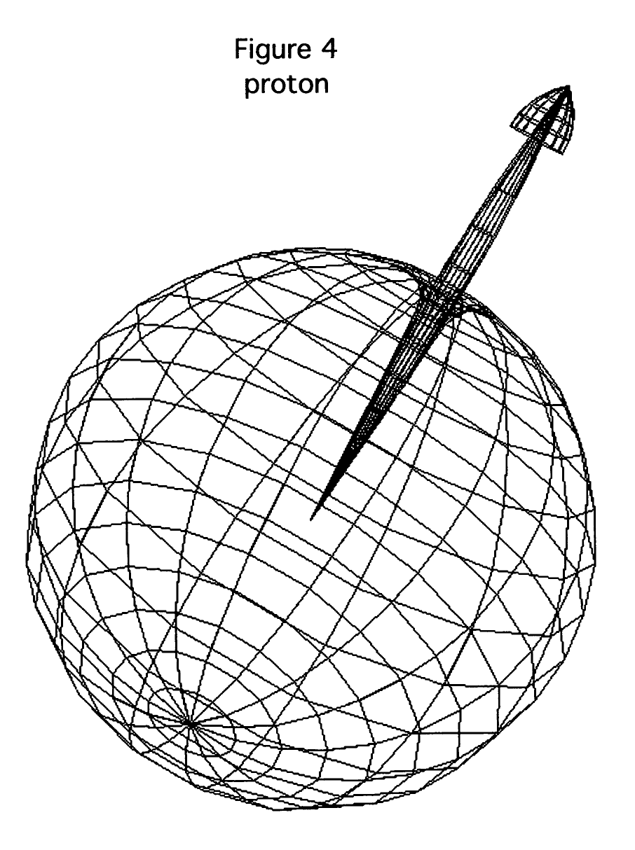

FIG. 5 depicts the form generated by the neutron or female perspective of the time/life equation.

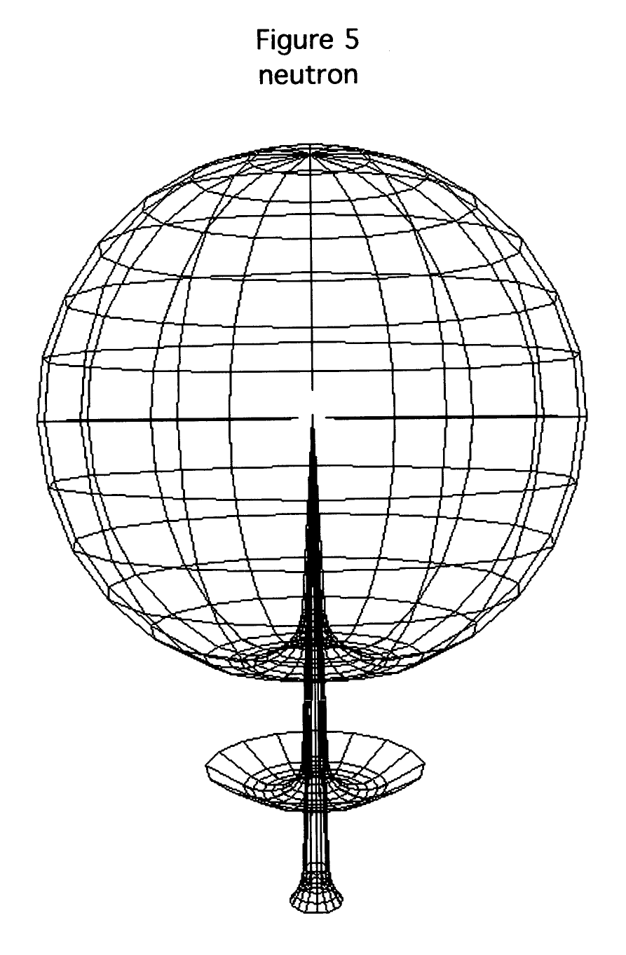

FIG. 6 depicts the form generated by the electron or bipolar perspective of the time/life equation.

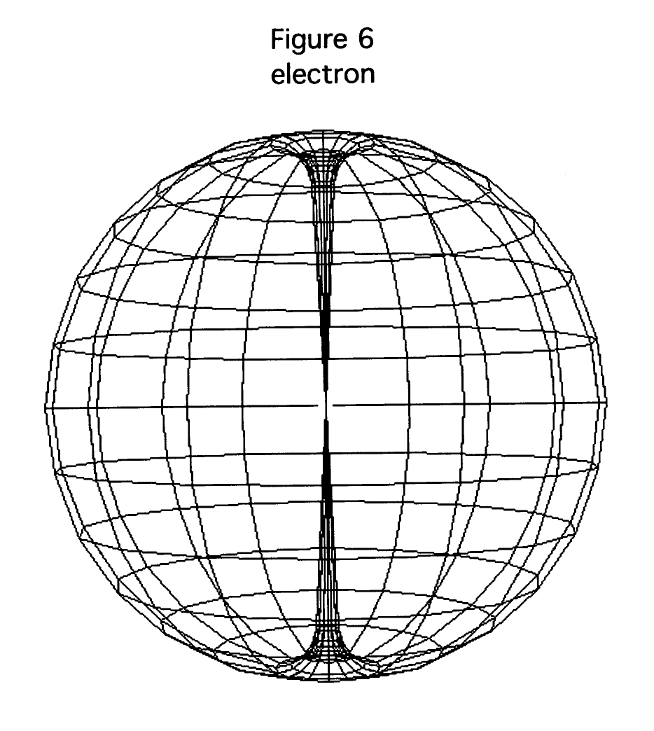

What is claimed is:

1. A field theory of time, life, light and gravity that provides a complementary frame of reference to related disciplines of study.

2. A mathematical formula that defines matter and energy as functions of time/life.

3. As an extension of claim 2, time/life theory predicts a practicable method of predictable human resurrection/reincarnation.
